(19) United States
(12) Patent Application Publication
(10) Pub. No.: US 2006/0072998 A1
(43) Pub. Date: Apr. 6, 2006

(54) Cargo lifting device

(76) Inventor: Su Jian, Guangzhou (CN)

Correspondence Address: PERKINS COIE LLP, POST OFFICE BOX 1208, SEATTLE, WA, 98111-1208, US

(21) Appl. No.: 10/534,898

(22) PCT Filed: Nov. 4, 2003
(86) PCT No.: PCT/CN03/00933

§ 371 Date: May 13, 2005

(30) Foreign Application Priority Data
Nov. 12, 2002 (CN) 022494154

(51) Int. Cl. B60P 1/00

(52) U.S. Cl. 414/556

(57) ABSTRACT

The present invention relates to a transport device, in particular, a vertical lifting device for cargo transfer. The lifting device according to the present invention includes hydraulic lifting assemblies 1, a fixture 2 and a lifting platform 3. The lifting platform 3 is connected to the fixture 2 via the hydraulic lifting assemblies 1. One end of each of the hydraulic lifting assemblies 1 is secured to the fixture 2 while the other end of each of the hydraulic lifting assemblies 1 is secured to the two sides of the lifting platform 3 respectively. The joints of the hydraulic lifting assemblies with the platform are located at the two sides of the platform instead of its near side. It is therefore possible that the panel of the lifting platform can be made of thinner plate. Accordingly, the slope of the platform is sufficiently reduced and less energy is required during the cargo transporting process.

### FIELD OF THE INVENTION

The present invention relates to a transport device, in particular, a vertical lifting device for cargo transfer.

### BACKGROUND OF THE INVENTION

Cargo transportation involves steps of loading and unloading. A vertical lifting device is very helpful when cargos are to be loaded or unloaded from one position to a higher or lower position. A cargo lifting device disclosed in the prior art comprises an end which is secured to a means of conveyance, e.g. to the rear portion of a van. A hydraulic mechanism drives a lifting platform to move vertically. The cargos are raised to higher positions, e.g. the base board of a carriage, from lower positions, e.g. the ground, by placing the cargos on the lifting platform. Such kind of a device is very helpful in cargo loading and unloading. However, since the hydraulic mechanism is generally secured to the near side of the lifting platform, i.e. the side which is near to the fixture, the lifting platform is thus required to be thick enough at the near side, so as to provide a space for the placement of the fixture of the hydraulic mechanism. In the meantime, the near side of the lifting platform is positioned right in the path along which the cargo is transported from the lifting platform to a carriage or from a carriage to the lifting platform. Since the distal side of the lifting platform, i.e. the side far away from the fixture, is generally quite thin so that it can approach to the ground as close as possible, the thickened near side of the platform inevitably results in the increase of the slope of the platform surface, which means a sharper slope and more energy for conveying the cargos.

### SUMMARY OF THE INVENTION

The present invention aims to overcome the drawbacks in the prior art by providing a cargo lifting device with simple structure and requiring less energy for conveying the cargos.

The object of the invention is achieved by providing a cargo lifting device comprising hydraulic lifting assemblies 1, a fixture 2 and a lifting platform 3. The lifting platform 3 is connected to the fixture 2 via the hydraulic lifting assemblies 1. One end of each of the hydraulic lifting assemblies 1 is secured to the fixture 2 while the other end of each of the hydraulic lifting assemblies 1 is secured to the two sides of the lifting platform 3 respectively.

In accordance with the present invention, the joints of the hydraulic lifting assemblies 1 with the lifting platform 3 are located at the two sides of the lifting platform 3, instead of the near side as disclosed in the prior art. It is thus possible that the panel of the lifting platform can be made of thinner plate. Accordingly, the slope of the platform is sufficiently reduced and less energy is required during the cargo conveying process.

### BRIEF DESCRIPTION OF THE DRAWINGS

The present invention will be further understood and appreciated from the following detailed description taken in conjunction with the drawings in which:

FIG. 1 is a pictorial illustration of the cargo lifting device in accordance with the prior art;

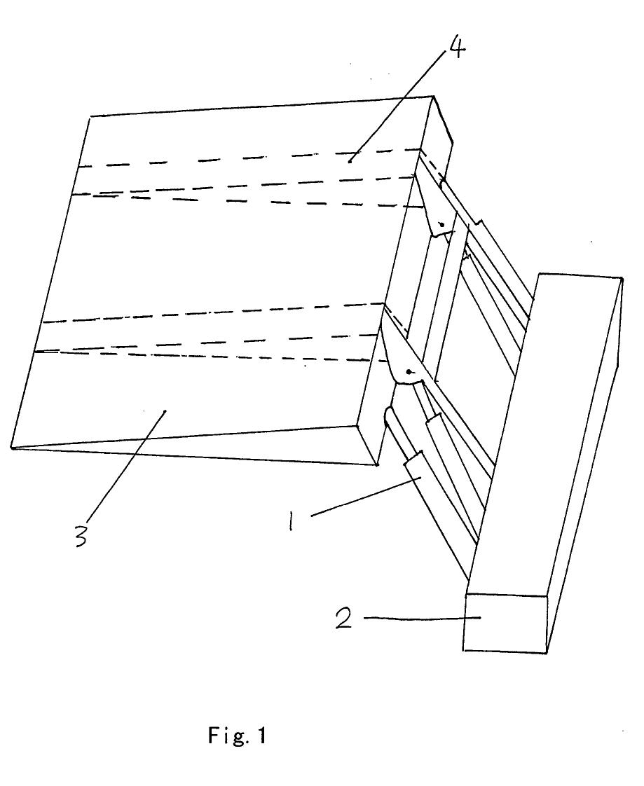

FIG. 2 is a pictorial illustration of the cargo lifting device in accordance with the present invention.

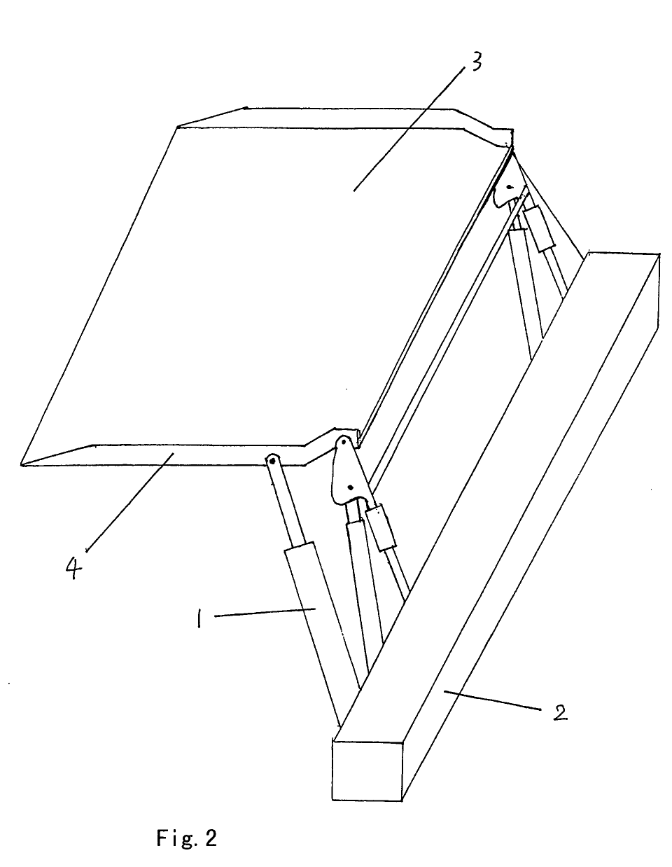

### DETAILED DESCRIPTION OF THE INVENTION

The cargo lifting device in accordance with the present invention includes hydraulic lifting assemblies 1, a fixture 2 and a lifting platform 3. The lifting platform is connected with the fixture 2 via the hydraulic lifting assemblies 1. One end of each of the hydraulic lifting assemblies 1 is secured to the fixture 2 while the other end of each of the hydraulic lifting assemblies 1 is secured to the two sides of the lifting platform 3 respectively.

According to the present invention, enforcement beams are secured to the two sides of the platform 3, instead of under the lifting platform as disclosed in the art. In the meantime, one end of each hydraulic assembly 1 is secured to each enforcement beam (4). In this way, it becomes possible that the lifting platform can be made of a thinner plate. Furthermore, the fixation of the hydraulic lifting assemblies 1 is also enhanced.

What is claimed is:

1. A cargo lifting device comprising hydraulic lifting assemblies 1, a fixture 2, a lifting platform 3, wherein the lifting platform 3 is connected to the fixture 2 via the hydraulic lifting assemblies 1, one end of each of the hydraulic lifting assemblies 1 is secured to the fixture 2 while the other end of the hydraulic lifting assemblies 1 is secured to the corresponding side of the lifting platform 3.

2. A cargo lifting device in accordance with claim 1, wherein the lifting platform 3 is provided with enforcement beams 4 at its two sides while the other end of each of the hydraulic lifting assemblies 1 is secured to the corresponding enforcement beam 4.
